(19) United States
(12) Patent Application Publication
(10) Pub. No.: US 2020/0301986 A1
(43) Pub. Date: Sep. 24, 2020

(54) SERVER AND VEHICLE

(71) Applicant: HONDA MOTOR CO., LTD., Tokyo (JP)

(72) Inventor: Kazuya WATANABE, WAKO-SHI (JP)

(21) Appl. No.: 16/825,113

(22) Filed: Mar. 20, 2020

(30) Foreign Application Priority Data
Mar. 22, 2019 (JP) 2019-054404

(51) Int. Cl. G06F 16/9535; H04W 4/48; G06F 16/9538

(52) U.S. Cl. CPC G06F 16/9535; G06F 16/9538; H04W 4/48

(57) ABSTRACT

A server that presents recommendation information to a vehicle is equipped with an attribute estimation unit that estimates an attribute of a user on the basis of a visit history of the user with the vehicle, and a removal unit that removes in advance, based on the attribute estimated by the attribute estimation unit, recommendation information that the user avoids from among the recommendation information to be presented on a display unit of the vehicle.

### CROSS-REFERENCE TO RELATED APPLICATION

This application is based upon and claims the benefit of priority from Japanese Patent Application No. 2019-054404 filed on Mar. 22, 2019, the contents of which are incorporated herein by reference.

### BACKGROUND OF THE INVENTION

### Field of the Invention

The present invention relates to a server and a vehicle configured to create recommendation information for a user on the basis of an attribute of the user, and to present such information to the vehicle.

### Description of the Related Art

In Japanese Laid-Open Patent Publication No. 2016-206715 (hereinafter referred to as JPA 2016-206715), a technique is disclosed in relation to a recommendation management server, in which recommendation information such as recommended vehicle type information or the like is presented to a user on the basis of a driving license acquisition period of the user, and for beginning drivers, recommendation information is provided of driving courses or the like that are not recommended (see paragraph [0018] of JPA 2016-206715).

### SUMMARY OF THE INVENTION

However, with the technique disclosed in JPA 2016-206715, in addition to recommendation information that is recommended, recommendation information that is not recommended is also provided to the user, and therefore, the time with which the user is involved with the recommendation information is prolonged, and the technique tends to be cumbersome.

The present invention has been devised taking into consideration such a problem, and has the object of providing a server and a vehicle in which recommendation information that the user avoids is removed and is not presented.

One aspect of the present invention is characterized by a server configured to present recommendation information to a vehicle, the server comprising an attribute estimation unit configured to estimate an attribute of a user on the basis of a visit history of the user with the vehicle, and a removal unit configured to remove in advance, based on the attribute estimated by the attribute estimation unit, recommendation information that the user avoids from among the recommendation information to be presented on a display unit of the vehicle.

Another aspect of the present invention is characterized by a vehicle to which recommendation information is presented on a display unit, the vehicle comprising an attribute estimation unit configured to estimate an attribute of a user on the basis of a visit history of the user with the vehicle, and a removal unit configured to remove in advance, based on the attribute estimated by the attribute estimation unit, recommendation information that the user avoids from among the recommendation information to be presented on the display unit.

According to the present invention, the recommendation information that the user avoids from among the recommendation information to be presented on the display unit inside the vehicle is removed in advance based on the attribute of the user that was estimated on the basis of the visit history of the user with the vehicle. Therefore, the recommendation information deemed to be necessary by the user is left remaining and is presented, and the user experience (the personal experience obtained by the user) afforded by the recommendation can be enhanced.

The above and other objects, features, and advantages of the present invention will become more apparent from the following description when taken in conjunction with the accompanying drawings, in which preferred embodiments of the present invention are shown by way of illustrative example.

### BRIEF DESCRIPTION OF THE DRAWINGS

FIG. 1 is a configuration diagram of an information providing system in which a vehicle according to a present embodiment and a server according to a present embodiment are connected via a communication network;

FIG. 2 is a block diagram of the vehicle according to the present embodiment;

FIG. 3 is a schematic sequence diagram provided to describe operations of the embodiment;

FIG. 4 is a creation table diagram for describing a process of creating an estimated attribute result database and an avoidance information database according to the embodiment;

FIG. 5 is a configuration diagram of an information providing system in which a vehicle according to a modification and a server according to a modification are connected via a communication network;

FIG. 6 is a block diagram of the vehicle according to the modification;

FIG. 7 is a schematic sequence diagram provided to describe operations of the modification; and

FIG. 8 is a creation table diagram for describing a process of creating an estimated attribute result database and an avoidance information database according to the modification.

### DETAILED DESCRIPTION OF THE PREFERRED EMBODIMENTS

Embodiments of a server and a vehicle according to the present invention will be presented and described in detail below with reference to the accompanying drawings.

### [Configuration]

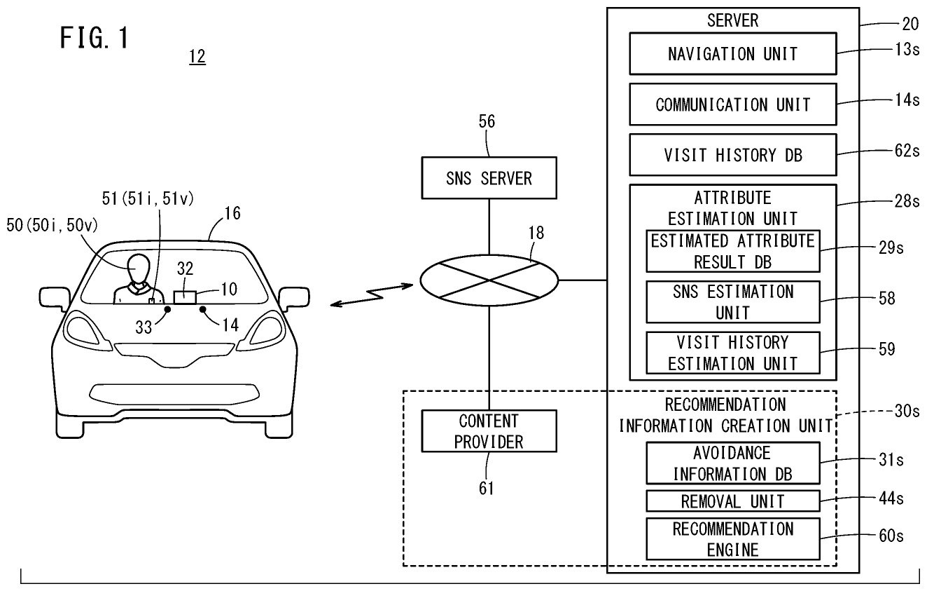

FIG. 1 is a configuration diagram of an information providing system 12 in which a vehicle 16 according to a present embodiment and a server 20 according to a present embodiment are connected via a communication network 18.

In addition to the vehicle 16 and the server 20, an SNS (Social Network Service) server 56 and a content provider 61 are connected to the communication network 18.

A communication unit 14 and a navigation device 10 are installed in the vehicle 16, and a communication unit 14s and a navigation unit 13s are installed in the server 20.

A user 50 such as a driver rides in the vehicle 16, and the user 50 carries a mobile terminal 51 such as a smartphone or the like. Further, a vehicle interior camera 33 is installed in the vehicle 16. The vehicle interior camera 33, for example, is a driver monitoring camera, and constantly captures images of the entirety of the vehicle interior including the head of the user 50 such as the driver or the like.

The navigation device 10, the server 20, and the mobile terminal 51 each includes a computer, which in addition to a CPU (central processing unit), a ROM (including an EEPROM), and a RAM (random access memory) serving as memories (storage units), includes input/output devices such as an A/D converter and a D/A converter and the like, and a timer serving as a time measurement means, and by reading out and executing programs stored in the ROM, functions as various function realizing units (function realizing means), for example, a control unit, a computation unit, a processing unit, and the like.

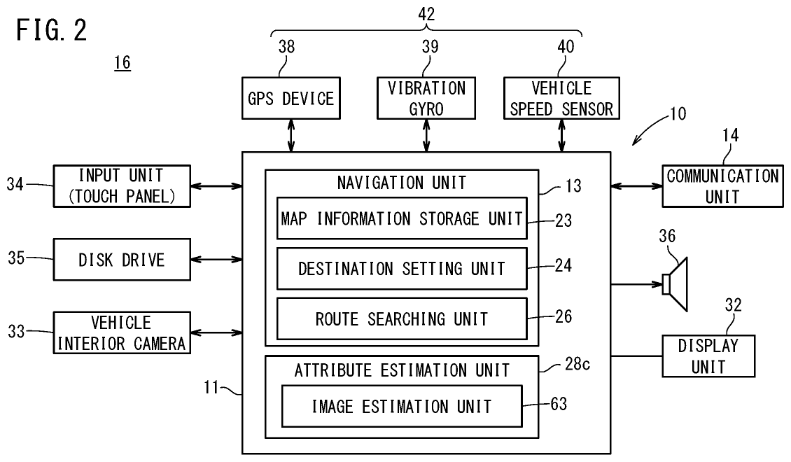

FIG. 2 is a block diagram of the vehicle 16 including a detailed configuration of the navigation device 10.

As shown in FIG. 2, the navigation device 10 is equipped with a navigation device main body 11, an input unit (touch panel) 34 connected to the navigation device main body 11, a disk drive (storage medium readout device) 35, the vehicle interior camera 33, a display unit (an image display device such as a monitor, a display or the like) 32, a speaker (sound output device) 36, a GPS device 38, a vibration gyro 39, and a vehicle speed sensor 40.

In this instance, the display unit 32 is made up from a liquid crystal display or the like that displays on a map the recommendation information and the result of a route search to a destination, etc., and the input unit 34, for example, is constituted by a touch panel (touch screen) on the display unit 32. The disk drive 35 is capable of reproducing, for example, respective disks such as a CD, a DVD, a BD or the like, which is a recording medium on which there is recorded map information including facility information.

The navigation device main body 11 includes a navigation unit 13 and an attribute estimation unit 28c including an image estimation unit 63.

The navigation unit 13 is equipped with a map information storage unit 23 in which map information including road information and facility information is stored, a destination setting unit 24, and a route searching unit 26 that performs a route search from a current location of the vehicle 16 to the destination to thereby obtain a recommended route.

On the basis of the map information stored in the map information storage unit 23, the navigation device 10 refers to the destination setting unit 24, and by means of the route searching unit 26, searches for a recommended route to the destination that was set by the user 50 through the input unit 34, and further guides the user 50 to the destination by guiding the vehicle 16 in accordance with the recommended route that was searched and retrieved.

Furthermore, the navigation device 10 is equipped with a current location detection device (current position detection device) 42 that functions as a current position detector or the like. The current location detection device 42 is a device that detects the current location of the host vehicle (user's own vehicle) 16, and for example, is constituted from the vibration gyro 39 that detects the direction in which the host vehicle 16 is traveling, the vehicle speed sensor 40 that detects the vehicle speed, and the GPS device 38 that detects signals from GPS satellites, etc.

On the basis of the current location of the vehicle 16 detected by the current location detection device 42, the navigation device 10 is capable of determining a route search starting point when searching for the recommended route.

As noted previously, when the destination is set by operation of the user 50 made on the input unit 34 with reference to the destination setting unit 24, the current location of the vehicle 16 detected by the current location detection device 42 is set as the route search starting point. On the basis of route calculation information, a route calculation to the set destination is performed by a predetermined algorithm, a route between the route search starting point and the destination is searched and retrieved, and the recommended route to the destination is obtained. In addition, the recommended route and a map of the vicinity of the recommended route are displayed on the display unit 32, and in accordance with the recommended route which is selected, and using voice guidance from the speaker 36 and a display on the display unit 32, instructions to turn left or right are carried out appropriately by the navigation device 10.

On the other hand, as shown in FIG. 1, in addition to a communication unit 14s and a navigation unit 13s, which possesses a higher-order function corresponding to the navigation unit 13 of the vehicle 16, the server 20 is equipped with a visit history database (visit history DB) 62s, an attribute estimation unit 28s, and a recommendation information creation unit 30s.

The attribute estimation unit 28s includes an SNS estimation unit 58, a visit history estimation unit 59, and an estimated attribute result database (estimated attribute result DB) 29s.

The recommendation information creation unit 30s is equipped with an avoidance information database (avoidance information DB) 31s, a recommendation engine 60s, and a removal unit 44s. Moreover, since the server 20 also obtains the recommendation information from the content provider 61 that is connected to the communication network 18, and presents such information to the vehicle 16, the recommendation information creation unit 30s of the server 20 is drawn in the form of a dashed partition line in which the content provider 61 is included.

### [Operations]

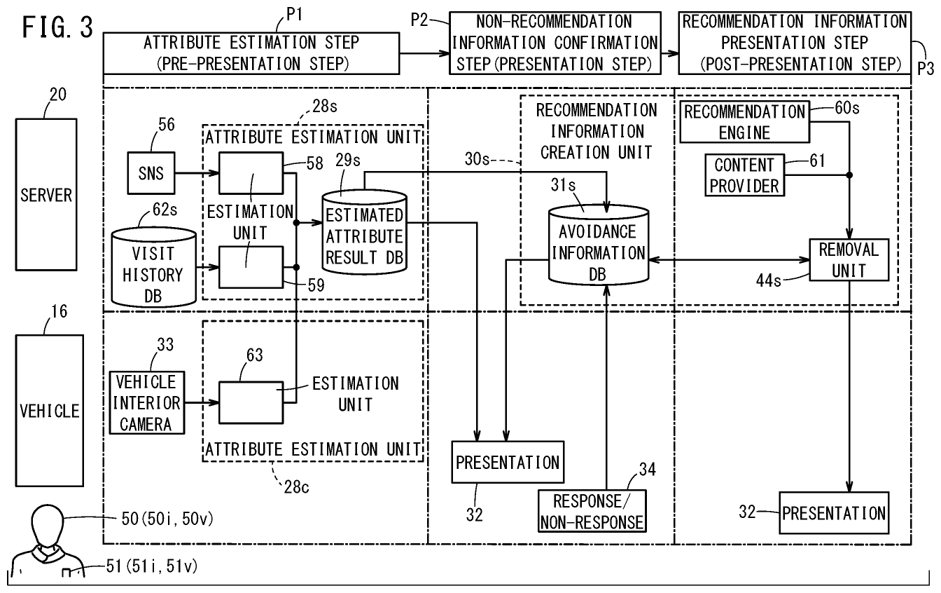

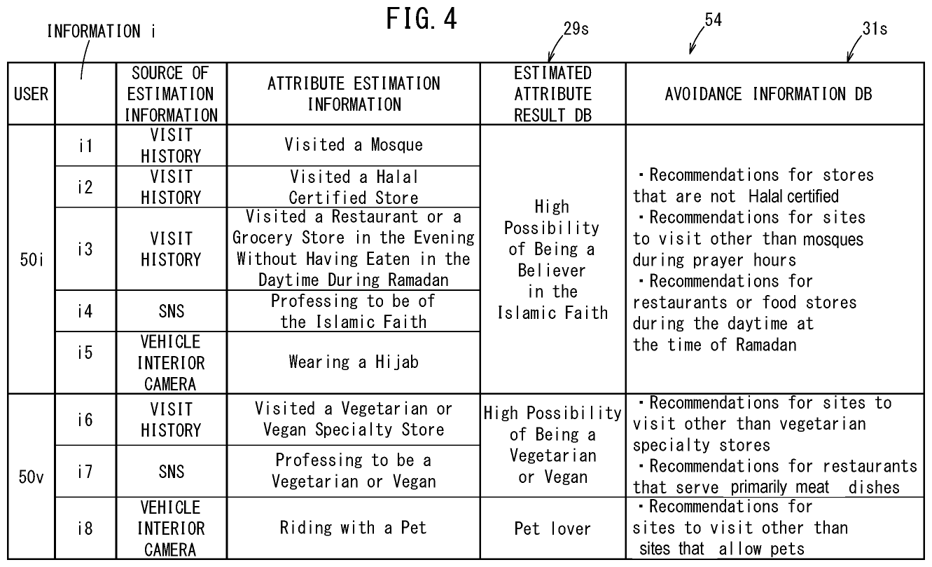

With reference to the schematic sequence diagram shown in FIG. 3 and the creation table diagram 54 shown in FIG. 4, descriptions will be given concerning operations of the information providing system 12 comprising the vehicle 16 and the server 20 which are configured basically in the manner described above.

In the sequence according to the sequence diagram shown in FIG. 3, the server 20, the vehicle 16, and the user 50 who is a driver (according to the present embodiment, a plurality of users 50i who are believers of the Islamic faith and users 50v who are vegetarians) are associated with each other, and an attribute estimation step (pre-presentation step) P1, a non-recommendation information confirmation step (presentation step) P2, and a recommendation information presentation step (post-presentation step) P3 are executed basically repeatedly. For example, when one attribute estimation step P1 has occurred, the non-recommendation information confirmation step P2 is performed with respect to the attribute estimation result, and the recommendation information presentation step P3 reflecting the confirmation result is always executed therewith.

Moreover, although separate vehicles 16 are used by the user 50i and the user 50v, in the present embodiment, in order to avoid complexity, the vehicle 16 will be described as an individual vehicle 16.

In the attribute estimation step P1 and the non-recommendation information confirmation step P2 shown in FIG. 3, an avoidance factor (avoidance information) for determining the recommendation information for the user 50 (in actuality, non-recommendation information that is a selective limiting factor) is detected, and then, the estimated attribute result DB 29s and the avoidance information DB 31s are respectively created.

### [Attribute Estimation Step (Pre-Presentation Step) P1]

First, in the attribute estimation step P1, the SNS estimation unit 58 of the attribute estimation unit 28s of the server 20 refers to the SNS server 56, and in the case that, from the information i4 (profile information) of the user 50i, the user 50i is professing to be of the Islamic faith, it is estimated that the user 50i possesses an attribute (Islamic religion) for which the possibility is high that he or she is a believer of the Islamic faith, and the attribute of the estimation result (Muslim, Islamic Religion) is stored in association with the user 50i in the estimated attribute result DB 29s. Moreover, the SNS server 56 acquires the information i4 on the basis of a usage history or the like of the user 50i on the mobile terminal 51i.

Further, in the attribute estimation step P1, the SNS estimation unit 58 of the attribute estimation unit 28s of the server 20 refers to the SNS server 56, and in the case that, from the information i7 (profile information) of the user 50v, the user 50v is professing to be a vegetarian (vegetarian or vegan), it is estimated that the user 50v possesses an attribute (orientation toward vegetarianism) for which the possibility is high that he or she is a vegetarian (attribute), and the attribute of the estimation result (vegetarian, orientation toward vegetarianism) is stored in association with the user 50v in the estimated attribute result DB 29s.

Furthermore, in the attribute estimation step P1, the visit history estimation unit 59 of the attribute estimation unit 28s of the server 20 refers to POI (Point of Interest) information, and floating car data indicative of position information and route information, which are included in the visit history database (visit history DB) 62s of the vehicle 16 extracted from the navigation device 10 of the vehicle 16 via the communication unit 14 and the communication network 18.

In this case, the visit history estimation unit 59 determines, from the information i1 (visit history) of the user 50i of the vehicle 16 that the user 50i has visited a mosque in a temple, from the information i2 (visit history) that the user 50i has visited a Halal certified store, and from the information i3 (visit history) that the user 50i has visited a restaurant or a grocery store during the evening without having eaten from sunrise to sunset during the month of Ramadan, that the user 50i possesses an attribute (Islamic religion) for which the possibility is high that he or she is a believer of the Islamic faith, and the attribute of the determination result (Muslim, Islamic Religion) is stored in association with the user 50i in the estimated attribute result DB 29s.

Further still, in the attribute estimation step P1, the visit history estimation unit 59 of the attribute estimation unit 28s of the server 20 refers to the POI information and the floating car data (FCD) indicative of the position information and the route information, which are included in the visit history database (visit history DB) 62s extracted from the navigation device 10 of the vehicle 16 via the communication unit 14 and the communication network 18.

In this case, on the basis of the fact that, from the information i6 (visit history) of the user 50v of the vehicle 16, the user 50v has visited the vegetarian or vegan specialty store, the visit history estimation unit 59 determines that the user 50v possesses an attribute for which the possibility is high that he or she is a vegetarian, and the attribute of the determination result (vegetarian, orientation toward vegetarianism) is stored in association with the user 50v in the estimated attribute result DB 29s.

Further still, in the attribute estimation step P1, in the case it is determined from the image information i5 of the vehicle interior camera 33 that the user 50i is wearing a hijab and is covering the hair, the image estimation unit 63 of the attribute estimation unit 28c of the vehicle 16 determines that the user 50i possesses an attribute (Islamic religion) for which the possibility is high that he or she is a believer of the Islamic faith. In this case, the attribute estimation unit 28c of the vehicle 16 associates the attribute of the estimation result with the user 50i and transmits it to the server 20, and the server 20 stores the attribute of the estimation result (Muslim, Islamic Religion) in the estimated attribute result DB 29s.

Further still, in the attribute estimation step P1, in the case it is determined from the image information i8 of the vehicle interior camera 33 that the user 50v is riding with a pet, in this instance a dog, the image estimation unit 63 of the attribute estimation unit 28c of the vehicle 16 determines that the user 50v possesses an attribute for which the possibility is high that he or she is a pet (dog) owner. In this case, the attribute estimation unit 28c of the vehicle 16 associates the attribute of the estimation result with the user 50v and transmits it to the server 20, and the server 20 stores the attribute of the estimation result (pet lover) in the estimated attribute result DB 29s.

### [Non-Recommendation Information Confirmation Step (Presentation Step) P2]

In the non-recommendation information confirmation step P2 which takes place after the attribute estimation step P1, the removal unit 44s of the recommendation information creation unit 30s of the server 20, based on a priority ordering of the avoidance information DB 31s that is associated with the attribute recorded in the estimated attribute result DB 29s, confirms the non-recommendation information by presenting the message, “Should stores that are not Halal certified not be displayed?” on the display unit 32 of the vehicle 16. Further, a confirmation is made by presenting the message, “Should stores other than vegetarian specialty stores not be displayed?” on the display unit 32. Furthermore, a confirmation is made by presenting the message, “Should stores other than those that allow pets not be displayed?” on the display unit 32.

Moreover, in the non-recommendation information confirmation step P2, the attribute estimation unit 28s or the removal unit 44s of the server 20 confirms the attribute recorded in the estimated attribute result DB 29s by presenting the message “Are you a believer of the Islamic faith?” on the display unit 32 of the vehicle 16. Alternatively, a confirmation may be made by presenting the message, “Are you a vegetarian or vegan?” on the display unit 32. Furthermore, a confirmation may be made by presenting the message, “Is a pet (dog) riding in the vehicle?” on the display unit 32.

In the case that a positive response is made by way of the input unit 34 in relation to the presented message, the recommendation information creation unit 30s stores the avoidance information, to be described below, in the avoidance information database (avoidance information DB) 31s. In the case of a negative response or a non-response, the avoidance information is not stored. Further, the priority ordering of the avoidance information DB 31s is updated on the basis of the response.

In the case it is determined that the user 50i possesses an attribute for which the possibility is high that he or she is a believer of the Islamic faith, the recommendation information creation unit 30s stores in the avoidance information DB 31s the following recommendations (1) to (5) in association with the user 50i as avoidance information, and more specifically, as non-suggested recommendations which are not presented to the user 50i. Moreover, avoidance information which is based on attributes that are not associated with the user 50 are stored in advance in the avoidance information DB 31s.

(1) Recommendations for stores that are not Halal certified

(2) Recommendations for sites to visit (visiting facilities) other than mosques during prayer hours

(3) Recommendations for restaurants or food stores during the daytime at the time of Ramadan

(4) Recommendations for restaurants using genetically modified plants as ingredients

(5) Recommendations for specialty stores for alcoholic beverages

On the other hand, in the case that the user 50v possesses an attribute for which the possibility is high that he or she is a vegetarian (vegetarian or vegan), and the user 50v is riding with a pet, the recommendation information creation unit 30s stores in the avoidance information DB 31s the following recommendations (6) to (9) in association with the user 50v as avoidance information, and more specifically, as non-suggested recommendations which are not presented to the user 50v of the vehicle 16.

(6) Recommendations for sites to visit other than vegetarian specialty stores

(7) Recommendations for restaurants that serve primarily meat dishes

(8) Recommendations for egg and dairy producing areas

(9) Recommendations for sites to visit other than sites that allow pets

### [Recommendation Information Presentation Step (Post-Presentation Step) P3]

In the recommendation information presentation step P3 which takes place after the non-recommendation information confirmation step P2, the server 20 creates recommendations on the basis of the visit history at sites visited by the user 50 in accordance with the recommendation engine 60s.

Further, the server 20 acquires recommendations from the content provider 61.

In this case, in relation to the recommendations of the recommendation engine 60s and the content provider 61, the recommendation information creation unit 30s executes, in the removal unit 44s and with reference to the avoidance information DB 31s, a presentation determination to determine whether the recommendations should be displayed on the display unit 32 of the vehicle 16 or not (not recommended).

In this manner, on the display unit 32 of the vehicle 16, based on the attribute estimated by the attribute estimation units 28s and 28c, from among the recommendation information to be presented on the display unit 32, the recommendations removed by the removal unit 44s are not presented.

According to the above-described embodiment, factors that limit the selection of the recommendations, such as a religious faith or an orientation toward vegetarianism of the user 50 or the like, are determined from the visit history or from the image of the vehicle interior camera 33, and recommendations that the user 50 avoids are removed in advance by the removal unit 44s of the server 20.

Therefore, for example, restaurants that serve meat are no longer recommended to a user 50v who is estimated to be a vegetarian, restaurants that serve pork, which is a land animal in accordance with the teachings of Haram, are no longer recommended to a user 50i who is estimated to be of the Islamic faith, and the like, and as a result, recommendations can be presented which are close to the attribute of the user 50 (50i, 50v).

In addition, when a recommendation is set as a non-suggested recommendation, since the agreement of the user 50 is obtained in the non-recommended information confirmation step P2, the accuracy of the recommendations (non-suggested recommendations) that are removed is improved.

### [Modifications]

### [Configuration]

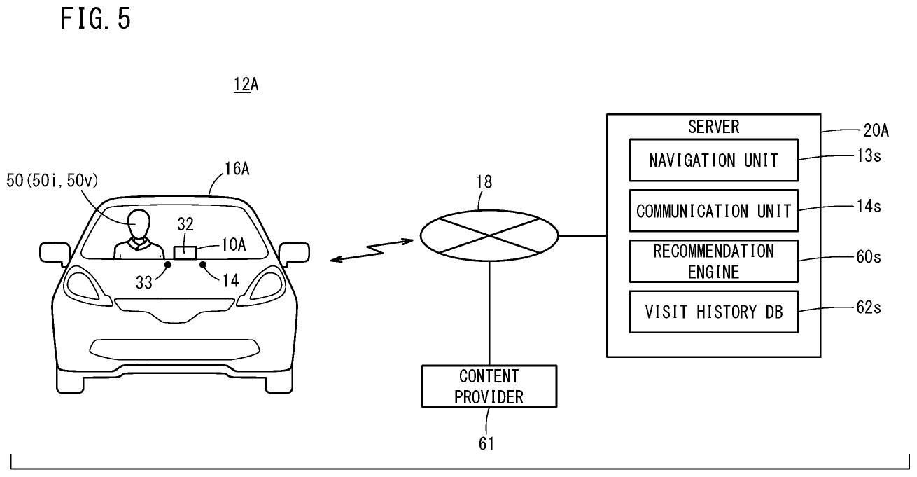

FIG. 5 is a configuration diagram of an information providing system 12A in which a vehicle 16A according to a modification and a server 20A according to a modification are connected via the communication network 18.

In the drawings referred to below, the same or corresponding parts as those shown in FIGS. 1 to 4 are denoted by the same reference numerals, and detailed description of such features is omitted.

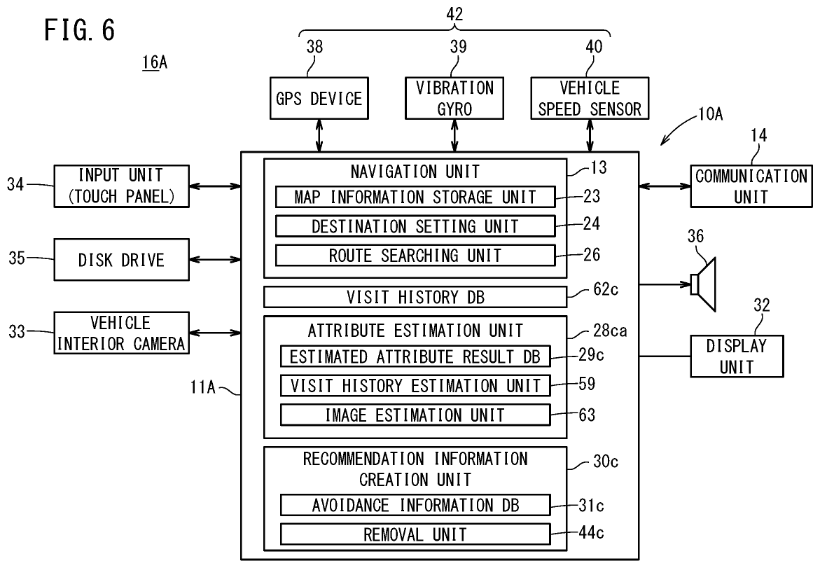

FIG. 6 is a block diagram of the vehicle 16A including a detailed configuration of the navigation device 10A.

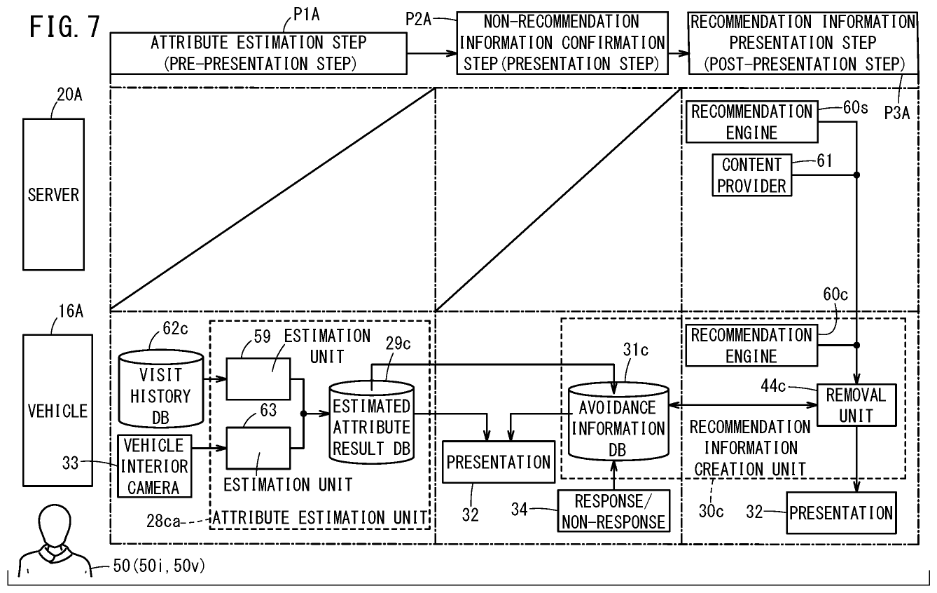

FIG. 7 is a schematic sequence diagram provided to describe operations of an information providing system 12A in which the vehicle 16A according to the modification and the server 20A according to the modification are connected via the communication network 18.

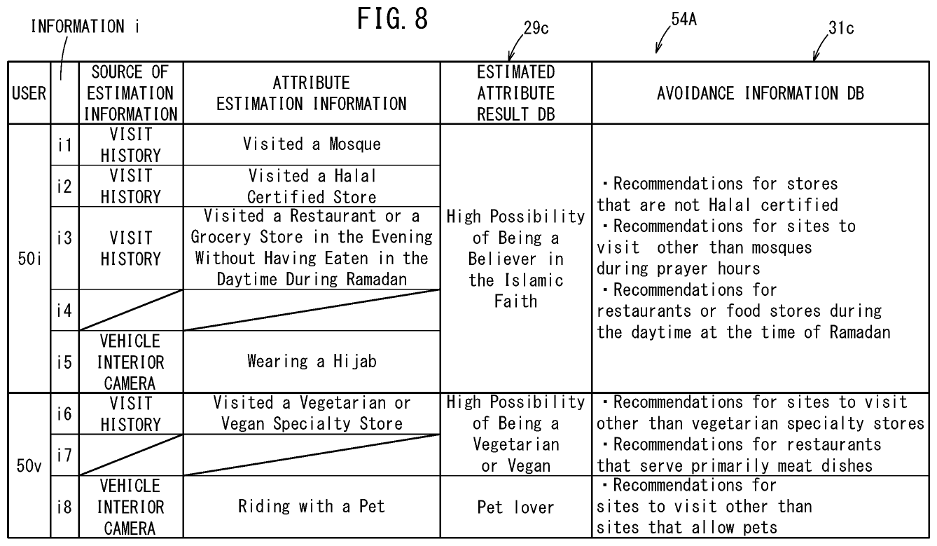

FIG. 8 is a creation table diagram 54A.

As shown in FIG. 7, with the information providing system 12A in which the vehicle 16A according to the modification and the server 20A according to the modification are connected via the communication network 18, an attribute estimation step P1A, a non-recommendation information confirmation step P2A, and a recommendation information presentation step P3A are executed exclusively by the vehicle 16A.

Therefore, as shown in FIGS. 6 and 7, separately from the visit history DB 62s of the server 20A, a visit history DB 62c is provided in a navigation device main body 11A of the vehicle 16A. An attribute estimation unit 28ca provided in the vehicle 16A is equipped with the image estimation unit 63, the visit history estimation unit 59, and an estimated attribute result DB 29c.

### [Operations]

With reference to the schematic sequence diagram shown in FIG. 7 and the creation table diagram 54A shown in FIG. 8, descriptions will be given concerning operations of the information providing system 12A comprising the vehicle 16A and the server 20A which are configured basically in the manner described above.

In the sequence according to the sequence diagram shown in FIG. 7, the vehicle 16A, and the user 50 (according to the modification as well, users 50i who are believers of the Islamic faith and users 50v who are vegetarians) are associated with each other, and an attribute estimation step (pre-presentation step) P1A, a non-recommendation information confirmation step (presentation step) P2A, and a recommendation information presentation step (post-presentation step) P3A are executed repeatedly.

In the attribute estimation step P1A and the non-recommendation information confirmation step P2A shown in FIG. 7, an avoidance factor (avoidance information) for determining the recommendation information for the user 50 (in actuality, non-recommendation information that is a selective limiting factor) is detected, and then, the estimated attribute result DB 29c and the avoidance information DB 31c are respectively created.

### [Attribute Estimation Step (Pre-Presentation Step) P1A]

In the attribute estimation step P1A, the visit history estimation unit 59 of the attribute estimation unit 28ca of the vehicle 16A refers to POI (Point of Interest) information, and floating car data indicative of the position information and the route information, which are included in the visit history DB 62c of the vehicle 16A extracted by the navigation device 10A of the vehicle 16A.

In this case, the visit history estimation unit 59 determines, from the information i1 (visit history) of the user 50i of the vehicle 16A that the user 50i has visited a mosque in a temple, from the information i2 (visit history) that the user 50i has visited a Halal certified store, and from the information i3 (visit history) that the user 50i has visited a restaurant or a grocery store during the evening without having eaten from sunrise to sunset during the month of Ramadan, that the user 50i possesses an attribute for which the possibility is high that he or she is a believer of the Islamic faith, and the attribute of the estimation result (Muslim, Islamic Religion) is stored in association with the user 50i in the estimated attribute result DB 29c.

Further, in the attribute estimation step P1A, on the basis of the fact that, from the information i6 (visit history) of the user 50v of the vehicle 16A, the user 50v has visited a vegetarian or vegan specialty store, the visit history estimation unit 59 determines that the user 50v possesses an attribute (orientation toward vegetarianism) for which the possibility is high that he or she is a vegetarian, and the attribute of the estimation result (vegetarian, orientation toward vegetarianism) is stored in association with the user 50v in the estimated attribute result DB 29c.

Further still, in the attribute estimation step P1A, in the case it is determined from the image information i5 of the vehicle interior camera 33 that the user 50i is wearing a hijab and is covering the hair, the image estimation unit 63 of the attribute estimation unit 28ca of the vehicle 16A determines that the user 50i possesses an attribute for which the possibility is high that he or she is a believer of the Islamic faith. In this case, the attribute estimation unit 28ca of the vehicle 16A associates the attribute of the estimation result with the user 50i, and stores the attribute in the estimated attribute result DB 29c.

Further still, in the attribute estimation step P1A, in the case it is determined from the image information i8 of the vehicle interior camera 33 that the user 50v is riding with a pet, in this instance a dog, the image estimation unit 63 of the attribute estimation unit 28ca of the vehicle 16A determines that the user 50v possesses an attribute for which the possibility is high that he or she is a pet (dog) owner. In this case, the attribute estimation unit 28ca of the vehicle 16A stores the attribute of the estimation result (pet lover) in the estimated attribute result DB 29c.

### [Non-Recommendation Information Confirmation Step (Presentation Step) P2A]

In the non-recommendation information confirmation step P2A which takes place after the attribute estimation step P1A, the removal unit 44c of the recommendation information creation unit 30c of the vehicle 16A, based on a priority ordering of the avoidance information DB 31c that is associated with the attribute recorded in the estimated attribute result DB 29c, confirms the non-recommendation information by presenting the message, “Should stores that are not Halal certified not be displayed?” on the display unit 32 of the vehicle 16A. Further, a confirmation is made by presenting the message, “Should stores other than vegetarian specialty stores not be displayed?” on the display unit 32. Furthermore, a confirmation is made by presenting the message, “Should stores other than those that allow pets not be displayed?” on the display unit 32.

Moreover, in the non-recommendation information confirmation step P2A, the attribute estimation unit 28ca or the removal unit 44c may confirm the attribute recorded in the estimated attribute result DB 29c by presenting the message “Are you a believer of the Islamic faith?” on the display unit 32 of the vehicle 16A. Alternatively, a confirmation may be made by presenting the message, “Are you a vegetarian or vegan?” on the display unit 32. Furthermore, a confirmation may be made by presenting the message, “Is a pet (dog) riding in the vehicle?” on the display unit 32.

In the case that a positive response is made by way of the input unit 34 in relation to the presented message, the recommendation information creation unit 30c stores the avoidance information, to be described below, in the avoidance information database (avoidance information DB) 31c. In the case of a negative response or a non-response, the avoidance information is not stored. Further, the priority ordering of the avoidance information DB 31c is updated on the basis of the response.

In the case it is determined that the user 50i possesses an attribute for which the possibility is high that he or she is a believer of the Islamic faith, the recommendation information creation unit 30c stores in the avoidance information DB 31c the following recommendations (1) to (5) in association with the user 50i as avoidance information, and more specifically, as non-suggested recommendations which are not presented to the user 50i. Moreover, avoidance information which is based on attributes that are not associated with the user 50 are stored in advance in the avoidance information DB 31c.

(1) Recommendations for stores that are not Halal certified

(2) Recommendations for sites to visit (visiting facilities) other than mosques during prayer hours

(3) Recommendations for restaurants or food stores during the daytime at the time of Ramadan

(4) Recommendations for restaurants using genetically modified plants as ingredients

(5) Recommendations for specialty stores for alcoholic beverages

On the other hand, in the case that the user 50v possesses an attribute for which the possibility is high that he or she is a vegetarian (vegetarian or vegan), and the user 50v is riding with a pet, the recommendation information creation unit 30c stores in the avoidance information DB 31c the following recommendations (6) to (9) in association with the user 50v as avoidance information, and more specifically, as non-suggested recommendations which are not presented to the user 50v of the vehicle 16A.

(6) Recommendations for sites to visit other than vegetarian specialty stores

(7) Recommendations for restaurants that serve primarily meat dishes

(8) Recommendations for egg and dairy producing areas

(9) Recommendations for sites to visit other than sites that allow pets

### [Recommendation Information Presentation Step (Post-Presentation Step) P3A]

In the recommendation information presentation step P3A which takes place after the non-recommendation information confirmation step P2A, the recommendation information creation unit 30c of the vehicle 16A creates recommendations on the basis of the visit history at sites visited by the user 50 in accordance with the recommendation engine 60c.

The recommendation information creation unit 30c acquires the recommendations from the recommendation engine 60s and the content provider 61 of the server 20A.

In this case, in relation to the recommendations of the recommendation engines 60c and 60s and the content provider 61, the recommendation information creation unit 30c executes, in the removal unit 44c and with reference to the avoidance information DB 31c, a presentation determination to determine whether the recommendations should be displayed or not (not recommended) on the display unit 32 of the vehicle 16A.

In this manner, on the display unit 32 of the vehicle 16A, based on the attribute estimated by the attribute estimation unit 28ca, from among the recommendation information to be presented on the display unit 32, the recommendations removed by the removal unit 44c are not presented.

According to the above-described modification, factors that limit the selection of the recommendations, such as a religious faith or an orientation toward vegetarianism of the user 50 or the like, are determined from the visit history or from the image of the vehicle interior camera 33, and recommendations that the user 50 avoids are removed in advance.

Therefore, for example, restaurants that serve meat are no longer recommended to a user 50v who is estimated to be a vegetarian, restaurants that serve pork, which is a land animal in accordance with the teachings of Haram, are no longer recommended to a user 50i who is estimated to be of the Islamic faith, and the like, and as a result, recommendations can be presented which are close to the attribute of the user 50 (50i, 50v).

In addition, when a recommendation is set as a non-suggested recommendation, since the agreement of the user 50 is obtained in the non-recommended information confirmation step P2A, the accuracy of the recommendations that are removed is improved.

### Inventions that can be Obtained from the Embodiments and Modifications

Hereinafter, inventions that can be obtained from the above-described embodiments and the modifications thereof will be described below. Moreover, in order to facilitate understanding, reference characters used in connection with the constituent elements described above (in the embodiments and modifications) are provided in parentheses; however, it should be understood that the constituent elements are not limited to those to which such reference characters have been provided.

The server (20) according to the present invention is characterized by a server that presents the recommendation information to the vehicle (16), the server (20) comprising the attribute estimation unit (28s) that estimates the attribute of the user (50) on the basis of the visit history of the user (50) with the vehicle (16), and the removal unit (44s) that removes in advance, based on the attribute estimated by the attribute estimation unit (28s), the recommendation information that the user (50) avoids from among the recommendation information to be presented on the display unit (32) of the vehicle (16).

In accordance with such a configuration, the recommendation information that the user (50) avoids, from among the recommendation information to be presented on the display unit (32) inside the vehicle (16), is removed in advance based on the attribute of the user (50) that was estimated on the basis of the visit history of the user (50) with the vehicle (16). Therefore, the recommendation information deemed to be necessary by the user (50) is left remaining and is presented, and the user experience (the personal experience obtained by the user) afforded by the recommendation can be enhanced.

Further, on the basis of the attribute estimated by the attribute estimation unit (28s), the removal unit (44s) causes the user (50) to select non-recommended information that is not to be recommended, and sets the attribute in the removal unit (44s) when a positive response is obtained from the user (50).

In this manner, since the attribute for which a positive response is obtained from the user (50) is set in the removal unit (44s), the accuracy of the removal determination made by the removal unit (44s) is improved.

Further, the removal unit (44s) preferably presents the attribute estimated by the attribute estimation unit (28s) to the display unit, and sets the attribute in the removal unit (44s) when a positive response is obtained from the user (50) with respect to the presented attribute.

In this manner, since the attribute for which a positive response is obtained from the user (50) is set in the removal unit (44s), the accuracy of the removal determination made by the removal unit (44s) is improved.

Furthermore, the attribute of the user (50) that is estimated may be at least one of an attribute of an orientation toward vegetarianism and a specific religious faith of the user (50).

In accordance with this feature, on the basis of at least one of the attribute of the orientation toward vegetarianism and the specific religious faith of the user (50), it is possible to further improve the accuracy of the recommendation information presented to the user (50) as well as the user experience.

Further still, the attribute estimation unit (28s) may estimate the attribute of the user (50) on the basis of information on a social networking service (SNS) of the user (50), in addition to the visit history with the user (50) in the vehicle (16).

In accordance with this feature, by reinforcing the estimation of the attribute of the user (50) on the basis of the information on the SNS of the user (50), it is possible to more accurately estimate the attribute of the user (50).

The vehicle (16) which receives the service from the server (20) is also included in the present invention.

The vehicle (16A) according to the present invention is a vehicle to which the recommendation information is presented on the display unit (32), the vehicle (16A) comprising the attribute estimation unit (28ca) that estimates the attribute of the user (50) on the basis of the visit history with the user (50) in the vehicle (16A), and the removal unit (44c) that removes in advance, based on the attribute estimated by the attribute estimation unit (28ca), the recommendation information that the user (50) avoids from among the recommendation information to be presented on the display unit (32).

In accordance with such a configuration, the recommendation information that the user (50) avoids, from among the recommendation information to be presented on the display unit (32) inside the vehicle (16A), is removed in advance based on the attribute of the user (50) that was estimated on the basis of the visit history of the user (50) with the vehicle (16A). Therefore, the recommendation information deemed to be necessary by the user (50) is left remaining and is presented, and the user experience (the personal experience obtained by the user) afforded by the recommendation can be enhanced.

Further, the vehicle interior camera (33) is provided, wherein the attribute estimation unit (28ca) estimates the attribute of the user (50) on the basis of the image information of the vehicle interior camera (33), in addition to the visit history of the user (50) with the vehicle (16A).

In accordance with this feature, from the image information of the vehicle interior camera (33), for example, information such as food products eaten by the user (50), the clothes (a hijab or indigenous clothing) worn by the user (50) or the like can be obtained, and from such information, by reinforcing the estimation of the attribute of the user (50), the attribute of the user (50) can be more accurately estimated.

The present invention is not limited to the Islamic religion referred to in the above-described embodiments, and it goes without saying that the features of the present invention may be applied to various religions such as Hinduism, Buddhism, Christianity or the like, and that various configurations could be adopted therein based on the descriptive content of the present specification.

What is claimed is:

1. A server configured to present recommendation information to a vehicle, the server comprising:
an attribute estimation unit configured to estimate an attribute of a user on the basis of a visit history of the user with the vehicle; and
a removal unit configured to remove in advance, based on the attribute estimated by the attribute estimation unit, recommendation information that the user avoids from among the recommendation information to be presented on a display unit of the vehicle.

2. The server according to claim 1, wherein, on the basis of the attribute estimated by the attribute estimation unit, the removal unit causes the user to select non-recommended information that is not to be recommended, and sets the attribute in the removal unit when a positive response is obtained from the user.

3. The server according to claim 1, wherein the removal unit presents the attribute estimated by the attribute estimation unit to the display unit, and sets the attribute in the removal unit when a positive response is obtained from the user with respect to the presented attribute.

4. The server according to claim 1, wherein the attribute of the user that is estimated is at least one of an attitude of an orientation toward vegetarianism and a specific religious faith of the user.

5. The server according to claim 1, wherein the attribute estimation unit is configured to estimate the attribute of the user on the basis of information on a social networking service of the user, in addition to the visit history of the user with the vehicle.

6. A vehicle configured to receive a service from the server configured to present recommendation information to a vehicle, the server comprising:
an attribute estimation unit configured to estimate an attribute of a user on the basis of a visit history of the user with the vehicle; and
a removal unit configured to remove in advance, based on the attribute estimated by the attribute estimation unit, recommendation information that the user avoids from among the recommendation information to be presented on a display unit of the vehicle.

7. A vehicle to which recommendation information is presented on a display unit, the vehicle comprising:
an attribute estimation unit configured to estimate an attribute of a user on the basis of a visit history of the user with the vehicle; and
a removal unit configured to remove in advance, based on the attribute estimated by the attribute estimation unit, recommendation information that the user avoids from among the recommendation information to be presented on the display unit.

8. The vehicle according to claim 7, further comprising:
a vehicle interior camera;
wherein the attribute estimation unit is configured to estimate the attribute of the user on the basis of image information of the vehicle interior camera, in addition to the visit history of the user with the vehicle.
